(19) United States
(12) Patent Application Publication
(10) Pub. No.: US 2026/0316512 A1
(43) Pub. Date: Oct. 15, 2026

(54) SERVICEABLE TORSION AXLES FOR TOWABLE VEHICLES

(71) Applicant: AVRO Ground Support Equipment Inc., Oxbow (CA)

(72) Inventor: Justin Waldner, Minnedosa (CA)

(21) Appl. No.: 19/463,766

(22) Filed: Jan. 29, 2026

Related U.S. Application Data
(60) Provisional application No. 63/787,321, filed on Apr. 11, 2025.

(51) Int. Cl. B60G 21/05

(52) U.S. Cl. CPC B60G 21/052; B60G 2200/21; B60G 2204/1434; B60G 2204/61; B60G 2300/04

(57) ABSTRACT

A serviceable torsion axle for a towable vehicle features a main axle beam, and mounting brackets affixed to the main axle beam for mounting thereof to a frame of the vehicle in offset relation therebelow. At each end region of the main axle beam, a respective torsion assembly features a mounted housing component affixed to the main axle beam, a removable housing component removably fastened to the mounted housing to form an assembled torsion housing, a torsion shaft extending into the assembled torsion housing, a torsion arm affixed to and radiating from the torsion shaft to rotatably support a wheel, and a set of elastomeric chords distributed around the torsion shaft inside the assembled torsion housing. Unfastening of the removable housing component enables opening of the housing for inspection and servicing, in contrast to conventional practice of discarding the entire torsion axle once the elastomeric chords have worn out.

### CROSS-REFERENCE TO RELATED APPLICATIONS

This application claims benefit under 35 U.S.C. 119(e) of U.S. Provisional Application No. 63/787,321, filed Apr. 11, 2025, the entirety of which is incorporated herein by reference.

### FIELD OF THE INVENTION

The present invention relates generally to suspension for towable vehicles, and more particularly to torsion axle suspension for such vehicles.

### BACKGROUND

In towed vehicles characterized by torsion axle suspension, the two wheels of each such axle are carried on two torsion arms that respectively radiate from two square torsion shafts at outer ends thereof, inner ends of which are each received in a larger square axle tube at a respective outer end thereof. Each torsion shaft, in its rotational orientation around a shared longitudinal axis of the axle tube and torsion shaft, is offset from the axle tube by roughly ninety degrees, so that each corner of the square torsion shaft faces a respective interior face of the square axle tube, rather than respective interior corner thereof. Inside the axle tube, a set of four elastomeric cords are distributed around each torsion shaft, and are each sandwiched between an interior corner of the square axle tube and an exterior face of the torsion shaft. Since the wheels are radially offset from the torsion shafts, loads experienced by each wheel impart torque on the respective torsion shaft via the torsion arm, rotation of which is constrained by the elastomeric cords, thus imparting a suspension effect to the wheel, independently of the other wheel at the opposing end of the axle.

Applicant is a manufacturer in the field of ground service equipment (GSE) for the aviation industry, in which torsion axles are commonly used to provide independent suspension to baggage carts and other similarly towable GSE. Conventionally, torsion axles are not treated as serviceable equipment that can be taken apart, inspected, serviced/repaired, and reassembled once there has been signs of service life deterioration, and are instead discarded and replaced in entirety. As a result, there is significant expense and material waste at the end of a conventional torsion axle's service life, when the true culprit of the axle's deteriorated operation may be solely attributable to degradation of the elastomeric chords inside the torsion axle, whose steel componentry (axle tube, torsion shafts, torsion arms, wheel spindles), denoting the bulk of the axle′ material construction and replacement cost, may still be in excellent, or at least satisfactory, condition for continued service life.

Accordingly, it would be desirable to provide a serviceable torsion axle design useable on GSE and various other towable vehicles to enable more cost effective and environmentally sound practices compared to conventionally wasteful and costly disposal of the entirety of an internally worn torsion axle.

### SUMMARY OF THE INVENTION

According to a first aspect of the invention, there is provided a serviceable torsion axle for a towable vehicle, said torsion axle comprising:
a main axle beam;
mounting brackets affixed to said main axle beam for mounting thereof to a frame of said towable vehicle in offset relation below said frame; and
at each of two end-adjacent regions of said main axle beam, a torsion assembly comprising:
   a mounted housing component affixed to the main axle beam;
   a removable housing component removably fastened to said mounted housing in an installed position cooperating with said mounted housing component to form an assembled torsion housing; and
   a torsion shaft extending into said assembled torsion housing at an outer end thereof;
   a torsion arm that is affixed to the torsion shaft outside the outer end of the assembled torsion housing, radiates outward from said torsion shaft and is configured to rotatably support a wheel on said torsion arm at a radial distance outward from the torsion shaft; and
   a set of elastomeric chords installed inside the assembled torsion housing and distributed around the torsion shaft in positions sandwiched between exterior surfaces of the torsion shaft and interior surfaces of the assembled torsion housing;
wherein the removable housing component is selectively removable from the mounted housing component to open up the completed torsion housing for inspection and servicing needs.

### BRIEF DESCRIPTION OF THE DRAWINGS

Preferred embodiments of the invention will now be described in conjunction with the accompanying drawings in which:

FIG. 1 is a top front right perspective view of a towable baggage cart featuring a steerable front torsion axle and a non-steerable rear torsion axle, each of a serviceable type of the present invention, for which the baggage cart is merely one non-limiting example of a vehicle on which the invention may be implemented.

FIG. 2 is an isolated rear right perspective view of the rear torsion axle from the vehicle of FIG. 1.

FIG. 3 is an isolated rear left perspective view of the rear torsion axle of FIG. 2, with the wheels thereof removed.

FIG. 4 is an isolated front left perspective view of the rear torsion axle of FIG. 3.

FIG. 5 is a front elevational view of the rear torsion axle of FIG. 3.

FIG. 6 is a cross-sectional view of the rear torsion axle of FIG. 5, as viewed along line A-A thereof.

FIG. 7 is a cross-sectional view of the rear torsion axle of FIG. 6, as viewed along line B-B thereof.

FIG. 8 is a front elevational view of a main axle beam of the rear torsion axle of the preceding figures, the rear elevational view of which is identical.

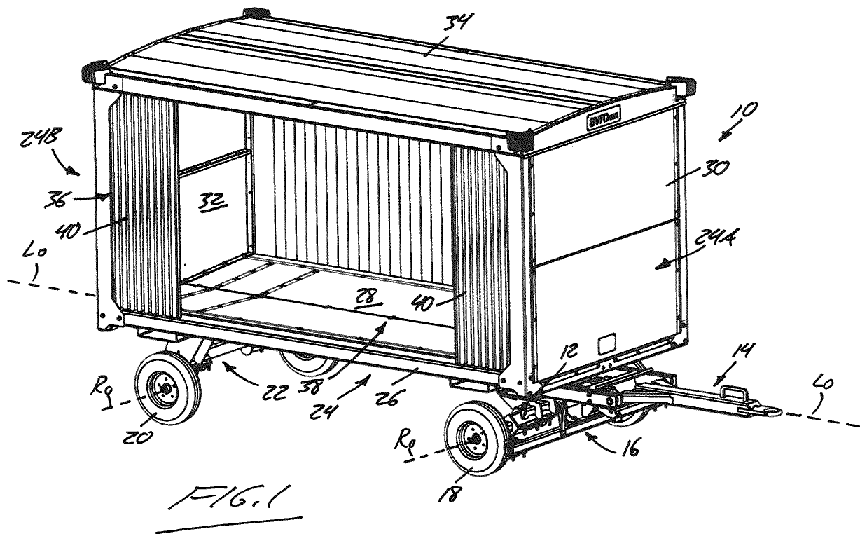

### DETAILED DESCRIPTION

Illustrated as merely one non-limiting example of an operating context for one or more inventive torsion axles of the present invention, the drawings show a towable baggage cart 10 with a steerable front axle assembly 12 and a fixed (non-steerable) rear axle 22. The front axle assembly 12 hosts both a pivotable towbar 14 of the baggage cart 10 and an associated towbar-actuated braking mechanism 16, the particular illustrated example of which is the subject of another co-pending application by the present Applicant. The baggage cart 10 is cooperatively supported on the ground by a pair of steerable front ground wheels 18 hosted by the steerable front axle assembly 12, and a pair of non-steerable rear ground wheels 20 instead installed on the fixed (non-steerable) rear axle 22. Supported atop the two axles is a vehicle body 24 of the baggage cart 10, whose purpose is to host the intended load of the vehicle, which in this case would be air-traveller baggage to be loaded or unloaded onto or from an aircraft in an airport operating environment.

In this baggage cart context, the vehicle body features a frame 26, a floor deck 28 installed atop the frame for placement of baggage atop the floor deck, rigid front and rear end walls 30, 32 standing upright from the floor deck 28 at opposing front and rear ends thereof, a roof 34 bridging between the top ends of the front and rear end walls 30, 32 in elevated overhead relation to the floor deck 28 in full-coverage relationship thereto, and curtained side walls 36 spanning respectively along opposing sides of the floor deck 28 between the front and rear end walls 30, 32. Each curtained side wall 36 frames therein a respective opening 38 through which an interior baggage space of the baggage cart, bound by the described walls and roof thereof, can be loaded an unloaded, which opening is selectively openable and closable by one or more movable curtains 40 slidably installed in the framed opening.

Both axle assemblies 12, 22 reside beneath the floor deck 28. Among the axle assemblies, the front axle assembly 12 resides nearest a front end 24A of the vehicle body 24, in this case denoted by the front end of the floor deck 28 and the associated front end wall 30 standing upright therefrom. The rear axle assembly 22 resides nearest a rear end 24B of the vehicle body 24, in this case denoted by the rear end of the floor deck 28 and the associated rear end wall 32 standing upright therefrom. The front and rear ends 24A, 24B of the vehicle body 24 are spaced apart from one another in a longitudinal direction of the baggage cart 10 denoted by a central longitudinal axis Lo running horizontally thereof at a longitudinal midplane of the baggage cart 10. Another horizontal directionality lying perpendicularly transverse to the longitudinal directionality is referred to herein as a lateral directionality. The rear axle assembly 22 is fixed to the frame 26, whereby the rotational axes Ro of the rear ground wheels 20 are of fixed orientation, running laterally of the baggage cart 10 in perpendicularity to the longitudinal axis Lo (at least in plan view, ignoring any camber angle of those rear ground wheels 20).

In contrast, the steerable front axle assembly 12 can swivel about a vertical steering axis that vertically penetrates the overlying floor deck 28 near the front end 24A of the vehicle body 24. Rotational coupling of the steerable front axle assembly 12 to the frame 26 is made at a frontal cross-member of the frame 26 that spans across the underside of the floor deck 28. The rotational axes Ro of the steerable front wheels 18, while parallel and coincident to one another (at least as seen in plan view thereof, ignoring any camber angle of such wheels) will thus vary in orientation depending on the rotational position of the steerable front axle assembly 12 about the steering axis at any given time. That said, the steerable front axle assembly 12 is shown in a straight-travel position corresponding to straight travel of the baggage cart 10 along the longitudinal axis Lo, in which the rotational axes Ro of the steerable front wheels 18 lie laterally of the baggage cart 10 in perpendicular relationship to the longitudinal axis Lo (at least in plan view). It is with reference to this straight-travel position of the steerable front axle assembly 12 that various positions and orientations of any componentry described herein should be interpreted for the easiest understanding by the reader, without overcomplication attributed to variability in the steering angle. Accordingly, any assessment of positionality, directionality and orientation necessary to construe the claimed invention in the context of a steerable axle should be assessed in this straight-travel state, though for simplicity, the detailed description that follows will be made in relation to the non-steerable (fixed) rear axle 22 that is fixed in an orientation of equivalent relationship to the straight-travel position of the steerable front axle assembly 12.

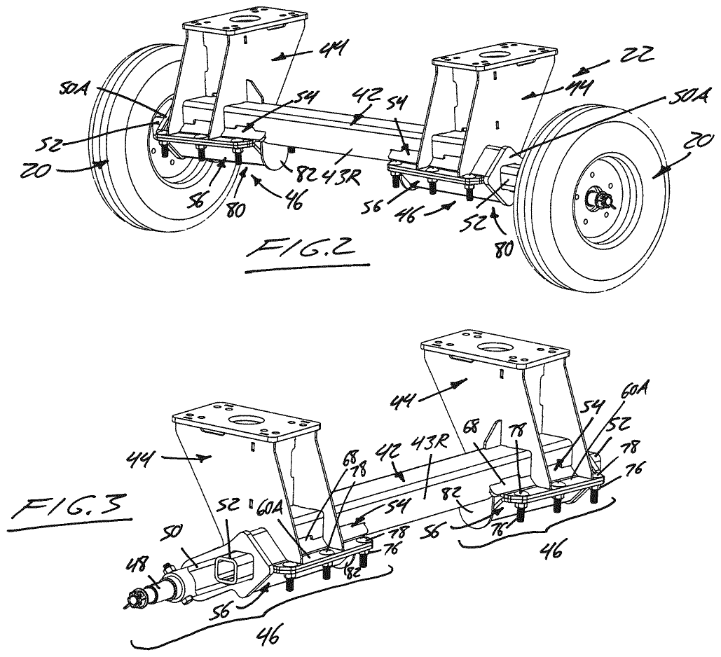

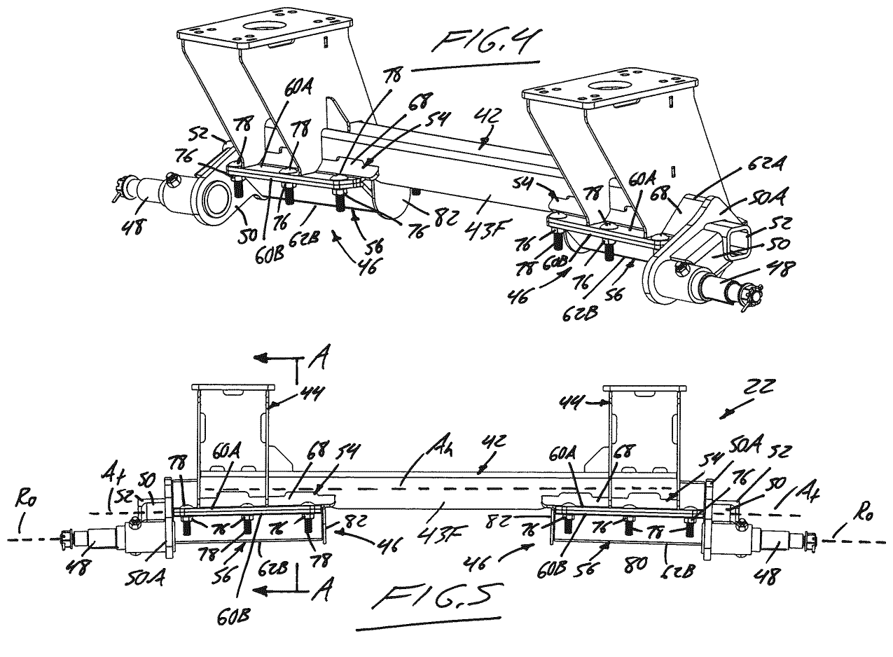

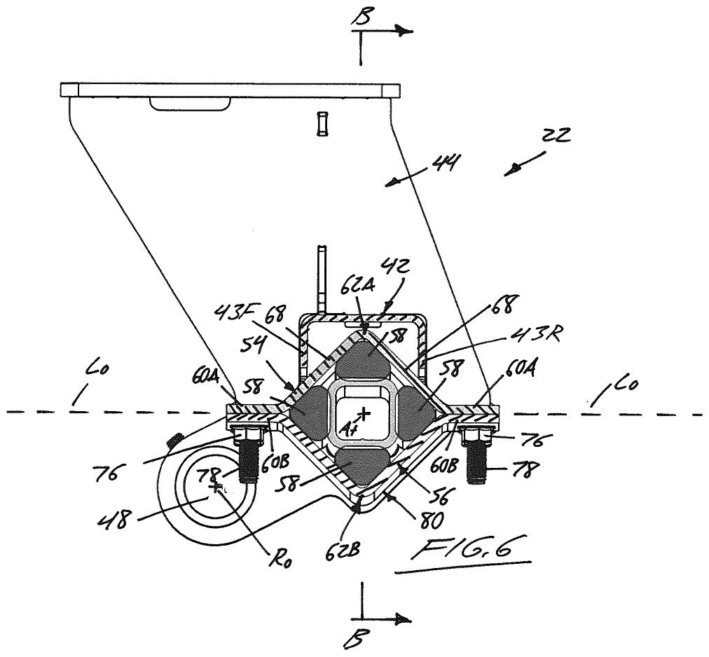

For optimal clarity of illustration, the rear axle 22 is shown in isolation from the rest of the baggage cart 10 in FIGS. 2 through 7. The isolated rear axle 22 is used to illustrate torsion axle componentry that is shared herein by the front axle 12. Details of the front axle 12 that differ from the rear axle 22 are details relating to the steerable nature of the front axle 12 and how it is installed to the frame 26 of the vehicle body 24 in order to permit such steerability, which itself is not pertinent to the torsion axle functionality that is the subject of the present application. Therefore, except where explicitly stated otherwise, any description made of the rear axle 22 for the purpose of providing an enabling disclosure and claim support for the inventive torsion axle design can likewise be equivalently applied to the front axle 12, whether steerable or not depending on the context in which such front axle is installed. Accordingly, the term torsion axle 22 is used from hereon generically to refer to the rear axle shown in FIGS. 2 to 7, but also to any other axle employing the equivalent torsion axle componentry, whether installed in a front or rear context, in a steerable or non-steerable implementation, and whether installed as a singular axle of a single-axle vehicle, or as one axle of a multi-axle vehicle.

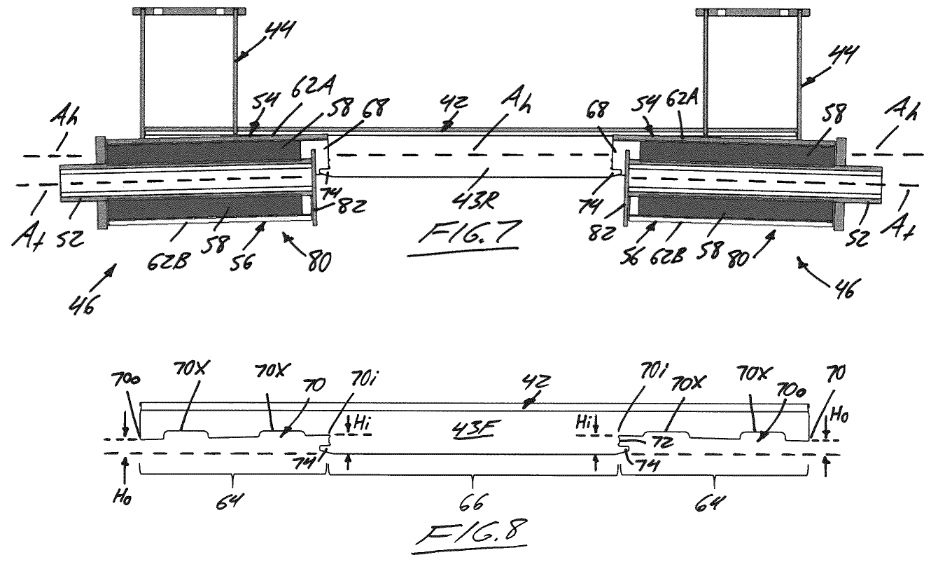

The torsion axle 22 features a main axle beam 42 that runs laterally of the vehicle body 24 at an offset elevation therebeneath, being attached thereto by a pair of mounting brackets 44 that are affixed to the main axle beam 42 and stand upright therefrom at spaced apart locations therelong, thus residing in laterally spaced relationship to one another when installed on the frame 26 of the vehicle body 24. The two wheels 20 of the torsion axle 22 reside respectively beyond the two ends of the main axle beam 42 so as to reside in respective adjacency to opposing sides of the vehicle body 24. Each wheel 20 is rotatably supported, in a manner indirectly coupled to the main axle beam 42, by a respective torsion assembly 46, components of which include a spindle 48 on which the wheel 20 is rotatable about its respective rotational axis Ro shared by that spindle 48, a torsion arm 50 on which the spindle 48 is carried near a distal end thereof furthest from the main axle beam 42, a square torsion shaft 52 to which the torsion arm 50 is fixed at or near an outer end of the torsion shaft 52 situated laterally beyond the respective end of the main axle beam 42, and an assembled torsion housing 80 composed of a mounted upper housing component 54 and a removable lower housing component 56 that, when assembled, cooperatively house therebetween a majority length of the torsion shaft 52 and a set of four elastomeric chords 58 (FIGS. 6-7) . In equivalent suspension functionality to a conventional torsion axle, rotation of the torsion shaft 52 is constrained by the chords 58 to impart suspension action to the wheel 20, which under loading, imparts a torque to the torsion shaft 52 via the torsion arm 48.

Unlike in the prior art, the elastomeric chords 58 are therefore not housed in the main axle beam 42 itself, and are instead hosted in an openable/closeable multi-piece torsion housing 80 that can be selectively opened up by unbolting and removing the removable lower housing component 56 in order to gain service access to the elastomeric chords 58 for inspection and, if warranted, replacement, to return the torsion axle to like-new operation condition without disposal and replacement of the other componentry, which is typically made of steel and carries notable expense.

In the illustrated embodiment, the main axle beam 42 is an open-bottomed U-shaped steel channel of notable length, and the upper and lower housing components 54, 56 are also both channel shaped and open at one side thereof, but are of shorter length than the axle beam 42 and of atypical cross-sectional shape. Each housing component 54, 56 is “witch-hat” shaped in cross-sectional planes lying normal to the length of the component, as perhaps best shown in FIG. 6, where two outside bolting flanges 60A, 60B form the brim of the witch-hat profile on opposite sides of a central triangular peak 62A, 62B that forms the pointed crown of the witch-hat. The suffixes A & B are used here to distinguish between features of the upper housing component 54 (suffix A) and those of the lower housing 56 (suffix B).

The triangular peak 62A of the upper housing component 54 is oriented in an upwardly-pointed and open-bottomed orientation, and ascends upwardly into the main axle beam 42 through the open bottom thereof. The outside bolting flanges 60A of the upper housing component 54 reside outside main axle beam 42 on opposite (front and rear) sides thereof. The upper housing component 54 of each torsion assembly 46 runs a partial length of the main axle beam 42 at a respective end region 64 thereof near a respective outer end of the main axle beam 42. At each of these end regions of the main axle beam 42, a bottom strip of each of the main axle beam's front and rear sidewalls 43F, 43R is cut away, imparting the main axle beam 42 with a shorter elevational height at each of these end regions than at a mid-region 66 between the two torsion assemblies 46. These sidewall cutaways 70 (FIG. 8) at each end region 64 accommodate seating therein of the downwardly divergent sidewalls 68 of the triangular peak 62A of the respective upper housing component. Each cutaway 70, at an inner end 70i thereof terminates in a receiving notch 72 into which a respective inner end of the upper housing component 54 is received during production of the torsion axle, which serves to seat the upper housing component 54 in proper alignment with a predetermined position in which the upper housing component 54 is then welded to the main axle beam 42 in permanent affixation thereto. The receiving notch 72 is partially delimited by a bottom catch tang 74 whose purpose is to hook under the inner end of the upper housing component 54 during such placement thereof in the fabrication process.

The triangular peak 62B of the lower housing component 56 is instead oriented in a downwardly pointed and open-topped orientation, to point downwardly away from the upper housing component 54 and the main axle beam 42 when the outside bolting flanges 60B of the lower housing component 56 are mated up against the outside bolting flanges 60A of the upper housing component 54 for fastened securement thereto using nuts 76 and bolts 78 that are engaged together via aligned fastening holes in the mated bolting flanges 60A, 60B. The result is best shown in FIG. 6, where the two triangular peaks of the witch-hat profiled housing components 54, 56 cooperate to form the assembled torsion housing 80 of internally square shape along the respective end region 64 of the main axle beam 42. The two triangular peaks 62A, 62B point vertically upward and downward, respectively, in opposition to one another in formation of top and bottom corners of the torsional housing's square cross-sectional profile. The two other corners of this square internal profile of the assembled torsion housing 80 are formed at the two mated pairs of bolting flanges 60A, 60B, which point horizontally and oppositely forward and rearward in the vehicle's longitudinal direction, as denoted by longitudinal axis Lo.

It is inside this bolted-together multi-piece torsion housing 80 that a majority length of the respective square torsion shaft 52 is received, through an open outer end of this torsion housing 80. Just outside this open outer end of the torsion housing 80, the respective torsion arm 50 is affixed to the torsion shaft 52 in a position radiating outward therefrom to carry the respective wheel spindle 48 of the torsion assembly 46. The four elastomeric chords 58 of the torsion assembly 46 are housed inside the assembled torsion housing 80 at the four internal corners thereof, each of which is faced by a respective one of the four sides of the square torsion shaft 52. Accordingly, each elastomeric chord 58 is compressed between the respective exterior side of the square torsion shaft 52 and the respective interior corner of the assembled torsion housing 80. To prevent any slippage of the torsion shaft 52 out from the outer end of the assembled torsion housing 80, a stop 82 is affixed to the opposing inner end of the torsion shaft 52, which resides just outside an inner end of the assembled torsion housing 80. The stop 82 is shaped and sized to be inadmissible through this otherwise open inner end of the torsion housing, and also serves as closure cap for this otherwise open end of the torsion housing to prevent, or at least limit or inhibit, ingress of environmental contaminants into the torsion housing. At the opposing outer end of the assembled torsion housing 80, this otherwise open outer end is similarly capped off by a flange plate 50A of the of the torsion arm 50.

To impart an intentional positive camber angle to the wheels 22, the torsion housings 80 tilt slightly downward in the laterally outward direction of the vehicle, i.e. toward the respective outer ends of the main axle beam 42. In the illustrated example, where the upper housing component 54 of each torsion housing 78 is seated in bottom cutouts 70 of the two sidewalls 43F, 43R of the main axle beam 42, this is achieved by an outwardly declined angulation of the top boundary of each such cutout 70, as best illustrated in FIG. 8 where the top boundary of each cutout 70 at the outer end 70o thereof can be seen to be of lower elevation than the top boundary of the cutout at the inner end 70i thereof, as evidenced by lesser cutout height Ho at the cutout's outer end 70o compared to greater cutter height Hi at the cutout's inner end 70i. FIG. 7 illustrates a resulting downwardly tilted axis At of each torsion housing 80 that is shared by its torsion shaft 52, versus a horizontal axis Ah possessed by the main axle beam 42.

Between the inner and outer ends 70i, 70o of the cutout 70, the upper boundary of each cutout 70 may have one or more raised areas 70X that, in the placed position of the upper housing component 54, each create a small gap between the sidewall 43F, 43R of the main axle beam 42 and the sloped sidewall 68 of the triangular peak 62A of the upper housing component 54 at these raised areas 70X residing between unraised areas 70Y of the cutout's upper boundary. These unraised areas 70Y of each cutout's upper boundary instead physically contacts the respective sidewall 68 of the triangular peak 62A of the upper housing component 54. The gaps at the raised areas 70X create a more exposed welding interface for welded attachment of the upper housing component 54 to the main axle beam 42.

At any time, should performance of either torsion assembly 46 of the torsion axle 22 start to drop off, suggesting degradation of the elastomeric cords 58 or some other problem, access to the interior of the torsion housing 80 for inspection and diagnosis of the problem, and replacement of the elastomeric chords 58 if warranted, is easily achieved by unbolting and removal of the lower housing components 56 of the assembled torsion housings 80, followed by bolted reattachment thereof once the inspection is completed, and the elastomeric chords 58 replaced, if warranted. Such repair denotes a substantial savings over removal, disposal and replacement of the entirety of the torsion axle, per conventional practice, when it is likely that only the elastomeric components 58 that have degraded, and the remaining componentry, typically of robust steel construction, likely in perfectly good working condition for continued operational use.

Since various modifications can be made in the invention as herein above described, and many apparently widely different embodiments of same made, it is intended that all matter contained in the accompanying specification shall be interpreted as illustrative only and not in a limiting sense.

1. A serviceable torsion axle for a towable vehicle, said torsion axle comprising:
a main axle beam;
mounting brackets affixed to said main axle beam for mounting thereof to a frame of said towable vehicle in offset relation below said frame; and
at each of two end-adjacent regions of said main axle beam, a torsion assembly comprising:
a mounted housing component affixed to the main axle beam;
a removable housing component removably fastened to said mounted housing in an installed position cooperating with said mounted housing component to form an assembled torsion housing; and
a torsion shaft extending into said assembled torsion housing at an outer end thereof;
a torsion arm that is affixed to the torsion shaft outside the outer end of the assembled torsion housing, radiates outward from said torsion shaft and is configured to rotatably support a wheel on said torsion arm at a radial distance outward from the torsion shaft; and
a set of elastomeric chords installed inside the assembled torsion housing and distributed around the torsion shaft in positions sandwiched between exterior surfaces of the torsion shaft and interior surfaces of the assembled torsion housing;
wherein the removable housing component is selectively removable from the mounted housing component to open up the assembled torsion housing for inspection and servicing needs.

2. The serviceable torsion axle of claim 1 wherein the mounted housing component is at least partially hosted inside the main axle beam.

3. The serviceable torsion axle of claim 2 wherein the main axle beam, at least at said end regions thereof, comprises an open-bottom channel, through an open bottom of which the mounted housing component is partially received in said open-bottom channel.

4. The serviceable torsion axle of claim 1 wherein said mounted housing component has an upper peak that, over at least a partial length of the mounted housing component, is hosted inside the main axle beam.

5. The serviceable torsion axle of claim 4 wherein said mounted housing component has a pair of divergent walls that diverge downwardly from said upper peak and pass through respective planes in which opposing side walls of the main axle beam reside.

6. The serviceable torsion axle of claim 5 wherein said mounted housing component comprises a pair of fastening flanges projecting respectively outward from said pair of divergent walls at distal ends thereof.

7. The serviceable torsion axle of claim 6 wherein said removable housing component has a lower peak that resides oppositely of the upper peak of the mounted housing component, a pair of upwardly-divergent walls that diverge upwardly from said lower peak, and a pair of fastening flanges projecting respectively outward therefrom at distal ends thereof in positions mated with the fastening flanges of the mounted housing component.

8. The serviceable torsion axle of claim 1 wherein said removable housing component has a lower peak that points downwardly away from the main axle beam and the mounted housing component.

9. The serviceable torsion axle of claim 8 wherein said removable housing component has a pair of upwardly divergent walls that diverge upwardly from said upper lower peak.

10. The serviceable torsion axle of claim 7 wherein said upwardly divergent walls pass through respective planes in which opposing sidewalls of the main axle beam reside.

11. The serviceable torsion axle of claim 9 wherein said pair of upwardly divergent walls having respective fastening flanges projecting therefrom at distal ends thereof.

12. The serviceable torsion axle of claim 1 wherein said assembled torsion housing has an internally square shape, two corners of which reside vertically opposite one another and another two corners of which reside horizontally opposite of one another, and the elastomeric cords are each sandwiched between one of said corners and a respective outer face of the torsion shaft.

13. The serviceable torsion axle of claim 1 wherein the mounted housing component resides above the removable housing component.

14. The serviceable torsion axle of claim 1 wherein the mounted housing component has an inner end thereof engaged in a receiving notch of the main axle beam.

15. The serviceable torsion axle of claim 1 wherein the completed torsion housing of each torsion assembly reaches beyond the respective outer end of the main axle beam.

16. The serviceable torsion axle of claim 1 wherein a sidewall height of the main axle beam is of shorter elevation at each of said end regions than at a mid-region between the torsion housing assemblies.

17. The serviceable torsion axle of claim 1 wherein the torsion shaft, at an inner end thereof situated outside an inner end of the completed torsion housing that opposes the outer end thereof, has a stopper affixed to said torsion shaft.
